(19) United States
(12) Patent Application Publication
(10) Pub. No.: US 2024/0265901 A1
(43) Pub. Date: Aug. 8, 2024

(54) SYSTEM AND METHOD FOR RECOGNISING CHORDS IN MUSIC

(71) Applicant: Lemon Inc., Grand Cayman (KY)

(72) Inventors: Gianluca MICCHI, London (GB); Katerina KOSTA, London (GB); Gabriele MEDEOT, London (GB); Pierre Nicholas CHANQUION, London (GB)

(21) Appl. No.: 18/569,193

(22) PCT Filed: Sep. 28, 2022
(86) PCT No.: PCT/SG2022/050700

§ 371 Date: Dec. 11, 2023

(30) Foreign Application Priority Data
Oct. 18, 2021 (GR) 20210100711
Oct. 26, 2021 (EP) 21204767.4

(51) Int. Cl. G10H 1/38

(52) U.S. Cl. CPC G10H 1/383; G10H 2210/571; G10H 2250/311

(57) ABSTRACT

A method of characterising chords in a digital music file comprises: receiving a portion of music in a digital format and for a first time interval in the music, a value of a chord feature from a set of chord features is predicted using a conditional Autoregressive Distribution Estimator (ADE). The ADE is modified using the predicted value for the chord feature and the modified ADE is used to predict a value for a different feature of the chord from the set of chord features. These operations are repeated until a value for each of the features in the set of chord features has been predicted for the first time interval. They are then repeated for subsequent time intervals in the portion of music.

### CROSS-REFERENCE TO RELATED APPLICATIONS

This application claims priority to EP Application No. 21204767.4, entitled SYSTEM AND METHOD FOR RECOGNISING CHORDS IN MUSIC, filed on Oct. 26, 2021, and priority to GR Application No. 20210100711, entitled SYSTEM AND METHOD FOR RECOGNISING CHORDS IN MUSIC, filed on Oct. 18, 2021, the entire contents of that application being incorporated herein by reference in its entirety.

The present invention relates to a system and a method for recognising chords in music.

### BACKGROUND

Harmony, together with counterpoint and form, is traditionally considered to be one of the three main parts of musical composition in Western classical tradition. This tradition is based on what is known as the tonal system, that is, a “theoretical formulation of certain psychological or physiological constraints upon the perception of sounds and their combination”. Their musical effect can be summarised in a few rules that are followed by most Western music (and also some non-Western music). Nevertheless, harmonic interpretation of music is complex due to its ambiguity. The same audio content can acquire different perceptual significance depending on its context: As a simple example, the chord symbols A ♯ major and B♭ major are acoustically indistinguishable but used in different contexts, hence the different spelling. Therefore, it is necessary to study the chord not as single entities but as a progression. This is usually done with the help of the Roman numeral notation (RN), which describes every chord in relation to the local key. RNs provide insights into harmony theory by exposing its invariances and symmetries. They highlight the function of each chord inside the progression and, for this reason, Automatic Chord Recognition (ACR) with RNs is also known as functional harmonic analysis.

The problem of harmony has a long academic history, but remains central to modeling and understanding most music, including modern pop; indeed, harmony is one of the main categories in which submissions to the 2020 A I Song Contest were judged. Therefore, it is natural that computational analysis of harmony has attracted so much attention in the music information retrieval “MIR” community.

There is a relatively vast body of work on ACR from audio signals. All these methods address chord symbol recognition instead of functional harmonic analysis. From the very first article published on the subject, the idea that has dominated the field is to interpret the audio signal using chroma features. This amounts to identifying and annotating the pitch content of the audio signal at each given time frame. Given how close the resulting audio representation resembles a symbolic music score, it is a bit puzzling to see how little attention symbolic ACR has received. There are only a few works, to our knowledge, that explicitly perform ACR on symbolic scores. However the interest on the topic has increased in more recent years, probably driven also by the growing attention to symbolic music for music generation Symbolic music makes a perfect entry point for the harder task of functional harmonic analysis because, with respect to audio data, it offers a much more direct representation of the musical content. There are two popular MIR approaches to functional harmonic analysis: One uses generative grammars, the other a deep learning based data-driven approach that can learn rules more flexibly.

Approaches to ACR of symbolic music face a common problem: how to deal with a vast chord vocabulary.

Another difficult issue that prevents such naive rule-based approaches from being successful is the identification of non-chord tones: Music often contains notes that are not part of the core harmony and designing a system that knows when to ignore these anomalies is a complex task to define algorithmically. Specifically for the task of functional harmonic analysis, there is also the problem of automatic key recognition, a subject that is well known in the art but still largely unsolved, partly due to ambiguities in its definition.

Finally, an important issue is that the number of possible output classes is very large. The naive approach of writing one output class for each possible chord is hindered by the combinatorial explosion of the output size (˜10 million classes) due to the presence of several elementary labels associated with each possible chord, making such approaches computationally intensive. Even considering only the most common chords, the possibilities easily exceed 100,000.

To address the above, it has been proposed to predict each feature (or label) of each chord (e.g. key or chord quality) independently. This reduces this the dimensionality of the output space by several orders of magnitude, making the problem computationally traceable again. However, this has been shown to lead to incoherent output labels. For example, for a harmony that can be interpreted as either A minor or C major, a system could equally well output A major or C minor.

In view of the limitations of the prior art, a technical problem underlying some embodiments of the present invention may be seen in the provision of a method for reducing the misclassification of chords, whilst also reducing the dimensionality of the output space.

The embodiments described below are not limited to implementations which solve any or all of the disadvantages of the known approaches described above.

### SUMMARY

This summary is provided to introduce a selection of concepts in a simplified form that are further described below in the Detailed Description. This summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

According to a first aspect, there is provided in the following a method of recognising chords in music. In general the method comprises receiving music data for a time interval and processing the music data in a machine learning model to output chord data corresponding to the time interval. The chord data comprises a set of chord features. In the machine learning model, a value of a chord feature from a set of chord features is predicted using a conditional Autoregressive Distribution Estimator (ADE). The ADE is modified using the predicted value for the chord feature and the modified ADE is used to predict a value for a different feature of the chord from the set of chord features. These operations are repeated until a value for each of the features in the set of chord features has been predicted for the first time interval.

In some implementations the portion of music, prior to being input to the ADE, may be combined with previous music inputs and/or previous outputs (predictions) before being input to the ADE. For example, another autoregressive model may be used in addition to the ADE. One example of another autoregressive model is a convolutional recurring neural network “CRNN”. Others will be familiar to those skilled in the art. The ADE may take as inputs the outputs from the additional autoregressive model.

It will be appreciated that these operations may then be repeated for subsequent time intervals in the portion of music.

The methods described herein may be performed by software in machine readable form on a tangible storage medium e.g. in the form of a computer program comprising computer program code means adapted to perform all the operations of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method operations may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

In other aspects, the present invention relates to a data processing system comprising a processor configured to perform the method for identifying chords, a computer program comprising instructions which, when the program is executed by a computer, cause the computer to carry out the method for identifying chords and/or a computer-readable medium comprising instructions which, when executed by a computer cause the computer to carry out the method for identifying chords.

The preferred features may be combined as appropriate, as would be apparent to a skilled person, and may be combined with any of the aspects of the invention.

### BRIEF DESCRIPTION OF DRAWINGS

Embodiments of the invention will be described, by way of example, with reference to the following drawings, in which:

FIG. 1 is a flowchart illustrating a series of operations that may be performed by a method according to some embodiments of the invention;

FIG. 2 is multi-hot 2D representation of the notes in a music file that may be used in some embodiments of the invention;

FIG. 3 is a block diagram showing components of a chord recognition algorithm (CRA) suitable for implementing the method illustrated in FIG. 1, according to some embodiments of the invention;

FIG. 4 is a flowchart of the operation of a CRA according to some embodiments of the invention;

FIG. 5 is a graph indicating the score of all tested models on selected metrics that may be obtained according to some embodiments of the invention;

FIG. 6 is a confusion matrix for the method shown in FIG. 1 for the label key;

FIG. 7 is a block diagram showing components of a computing system in which a CRA according to some embodiments of the invention may be implemented.

Common reference numerals are used throughout the figures to indicate similar features.

### DETAILED DESCRIPTION

Embodiments of the present invention are described below by way of example only. These examples represent the best mode of putting the invention into practice that are currently known to the applicant although they are not the only ways in which this could be achieved. The description sets forth the functions of the example and the sequence of operations for constructing and operating the example.

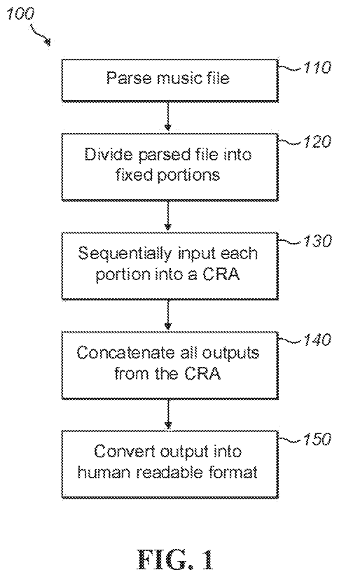

FIG. 1 is a flow chart illustrating a method 100 for identifying and/or characterising chords in a digital music file according to some embodiments of the invention. The arrows represent the direction of the flow of data. The method 100 can be used to identify and/or characterise chords in a symbolic music file such as a MIDI or MusicXML file. However, it can be appreciated that such a method could also be extended to chords in any kind of digital music file, such as such as MP4 or a M4A file. It should be noted that the methods described here are concerned only with the harmony in the music and not the melody. An aim of some of the methods is to identify the harmony so that it can be used for example in re-mixes. The identified harmony can be represented in any suitable form. One example is a lead sheet commonly used for jazz harmonies, others are described in the following.

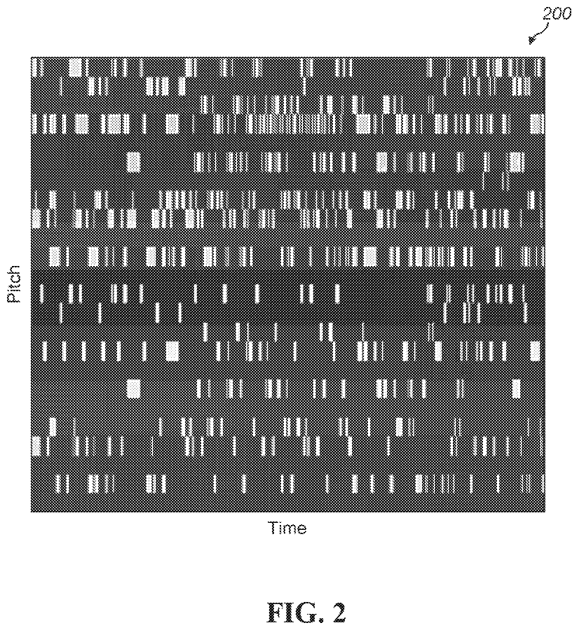

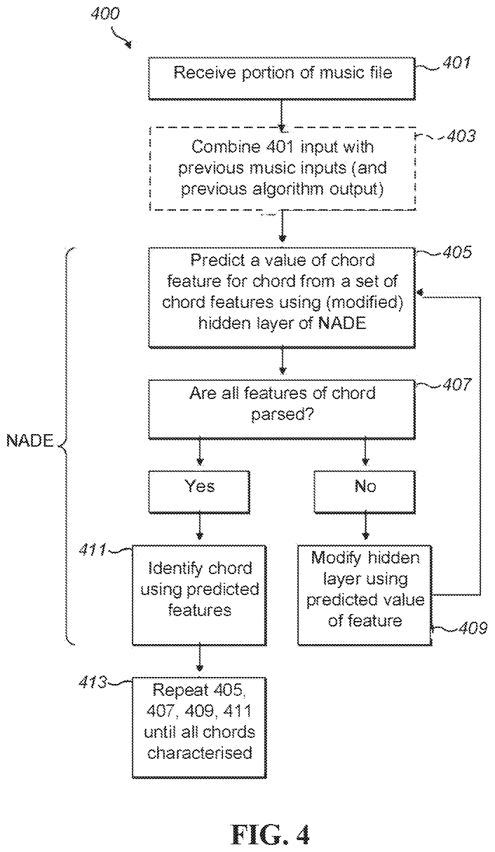

At operation 110, raw data from a music file (such as a symbolic music file or other digital music file) is parsed, converting it into a format that is accepted to a chord recognition algorithm “CRA” whose operations form part of the method 100 and are described further with reference to FIG. 4. For example, parsing the data may produce a “multi-hot” 2-dimensional (2D) representation of the all the notes in the music file. An example 200 of such a representation of parsed data is shown in FIG. 2, where the pitch of the notes is plotted against time for a subset of data from a music file. The pitch axis will be 1 (represented by the white vertical lines) if the associated note is active or 0 otherwise (represented as black). In the example of FIG. 2 the plot is quantised with a frame-length equivalent to a 1/32^{nd} note. The width of the vertical lines denotes the duration of that particular note.

In some embodiments, the data from the music file is also parsed to produce a multi-hot 2D representation of the metrical structure of the music file during the same operation (110), described further below. Like before, the representation may be quantised with a frame-length equivalent to a 1/32^{nd} note. The representation comprises two 1-dimensional (1D) vectors put together. The first vector is 1 whenever a new measure starts and 0 otherwise. The second vector is 1 whenever a new beat starts and 0 otherwise.

Referring back to FIG. 1, at operation 120 the parsed data is divided into portions of fixed size (e.g. set of 80 crochets per portion). At operation 130, each portion is separately and sequentially inputted into the CRA. The output of the CRA is an encoded version of the initial raw music file, with the chords correctly identified for each time interval in the input music portion. Subsequently, at operation 140 the output from the CRA is concatenated into a single file, and then converted into human readable format at operation 150 (e.g. a .rntxt file; .csv table; .json file that can be read by Dezrann; or an annotated MusicXML file).

The method 100 of FIG. 1 may be carried out in any computing system. The invention may be implemented in software using one or more algorithms operating on a suitably configured processor. The operations of the methods may be carried out on a single computer or in a distributed computing system across multiple locations. The software may be client based or web based, e.g. accessible via a server, or the software may be a combination of client and web based software.

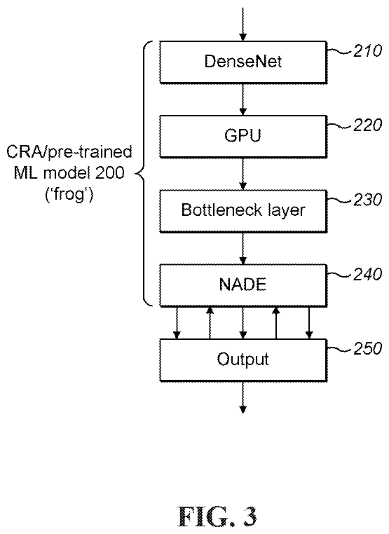

FIG. 3 provides further details on the structure and operation of the CRA. The CRA 200 algorithm is a pre-trained machine learning (ML) model comprising, in the example of FIG. 3, four separate blocks, and receives as input a portion of the parsed data at operation 130 (see also FIG. 1). A CRA typically operates using hyper-parameters. The hyper-parameters of CRA 200 may be selected with the help of Distributed Asynchronous Hyper-parameter Optimization or “hyperopt”, as is known in the art.

In general, the CRA of FIG. 3 is configured to analyse chords through separate but coherent predictions of their features through the addition of a NADE to a CRNN architecture. A CRNN architecture is not essential and a RNN architecture may be used. A NADE is not essential and a different type of autoregressive distribution estimator, which we refer to here as “ADE”, may be used.

A NADE has been applied to music generation, see for example C. Z. A. Huang, T. Cooijmans, A. Roberts, A. Courville, and D. Eck, “Counterpoint by convolution,” in Proceedings of the 18th International Society for Music Information Retrieval Conference, 572ISMIR 2017, 2017, pp. 211-218. [Online]. Available: 573 https://coconets.github.io/, and N. Boulanger-Lewandowski, Y. Bengio, and P. Vincent, “Modeling temporal dependencies in high-dimensional sequences: Application to polyphonicmusic generation and transcription,” in Proceedings of the 29th International Conference on Machine Learning, ICML 2012, vol. 2, 6 2012, pp. 1159-1166.[Online]. Available: http://arxiv.org/abs/1206.6392.

The first block 210 of CRA 200 is a densely connected convolutional network or DenseNet 210 for example as described in G. Huang, Z. Liu, L. Van Der Maaten, and K. Q. Weinberger, “Densely connected convolutional networks,” in Proceedings—30th IEEE Conference on Computer Vision and Pattern Recognition, CVPR 2017, vol. 2017-Janua, 2017, pp. 2261-2269. [Online]. Available: https://github.com/liuzhuang13/DenseNet. In an example, the DenseNet 210 is further divided into three blocks (not shown), each block comprising a plurality layers. In another example, a first block of DenseNet 210 has three convolutional layers, each made of 10 filters of size 7 (i.e. a 7×7 matrix). The remaining two blocks of DenseNet 210 are identical, each with 2 layers made of 4 filters of size 3. DenseNet 210 identifies local features in the input data.

The output of DenseNet 210 is inserted into a bi-directional Gated Recurrent Unit (GRU) 220, which analyses the consecutive chords. In an example, the GRU 220 has 178 hidden neurons (not shown) and is trained with a dropout of 0.2.

The model CRA 200 additionally comprises a bottleneck layer 230 containing fewer nodes than in previous layers, in this example implemented with a fully connected linear layer in which every neuron in one layer is connected to every neuron in another layer. In an example, the bottleneck layer 230 comprises 64 neurons. Its function is to summarise the information from bottom layers and discard useless information, thus reducing the dimensionality of the system. The output of the bottleneck layer 230 may be connected to the CRA output 250. The DenseNet 210 block, GRU 220 block, and the bottleneck layer 230 together form a Convolutional Recurrent Neural Network (CRNN) 260. The chords are then characterised, or classified, using a conditional Autoregressive Distribution Estimator (ADE). In an illustrated example, the ADE is a Neural Autoregressive Distribution Estimator “NADE”.

Thus, the bottleneck layer 230 additionally connects the GRU 220 to a NADE 240, in this example forming a final layer of the CRNN. In one example, the training of the NADE 240 is done with an ADAM (Adaptive Moment Estimation) optimiser with a learning rate of 0.003. An example ADAM optimiser is described in Diederik P. Kingma, Jimmy Ba “Adam: A Method for Stochastic Optimization.” Available: https://arxiv.org/abs/1412.6980. The output from the CRNN is used to determine the initial biases of the NADE 240. More specifically, the output of the bottleneck layer 230 is used to determine the initial biases of the NADE 240. As described in more detail with reference to FIG. 4, the output from a hidden layer of the NADE may be used to modify the layer for its next operation. Thus FIG. 3 shows output from the NADE being fed back into the NADE for this purpose.

Given a musical context, that is, a portion of a musical score between times t₀ and t₁, the prediction of features of a single chord at time t∈[t₀; t₁] will firstly be considered. It is assumed that each time interval in the portion includes a chord. As will be described below, a chord can be classified using a plurality of features also referred to here as labels. This means that the output class of the chord can be represented as a variable in a multi-dimensional space. If those dimensions were all independent, one could project the distribution on each axis and independently estimate each projection of the distribution. This is the case, for example, of a rectangular uniform distribution in a 2D space, which can be written as a product of two independent uniform distributions: p(x,y) pₓ(x)p_{y}(y).

However, if the distribution is more complex the above is no longer true. What one can always do without loss of generality is to determine an ordering of the dimensions (features) and estimate their value sequentially, conditioning each dimension given the result of all the preceding ones. This approach is at the heart of the NADE 240. An example set of features is considered in the following with an example ordering. The methods described here may be implemented with any number of features greater than two, in any order.

FIG. 4 shows the operation of a CRA according to some embodiments of the invention. The flow shown in FIG. 4 shows the optional use of an additional algorithm, for example a CRNN, to combine the input with previous inputs and/or outputs, at operation 403 to be described further below. As noted previously, embodiments of the invention are not limited to CRNNs. For example a RNN may be used, as is known in the art. The flow begins with the receiving of data from a digital music file, for example a portion from a larger file as described above. This, data, including data from earlier operations where performed, determine the state of the CRNN, if used, at any given moment in time. The state of the CRNN may be used to determine initial biases for the NADE. Subsequent operations may be performed in the NADE.

The NADE 240 may be composed of two parts: a visible layer that is made of as many neurons as there are dimensions in the distribution that is to be encoded, and a hidden layer. The number of dimensions is equal to the total number of features (or labels) that characterise each chord. At each operation (of the execution of the NADE 240), the content of the hidden layer is used to determine the value of the next neuron of the visible layer. The output sampled from the newly-updated neuron is then reinjected into the hidden layer to inform the decision on the next operation.

This reinjection is illustrated in FIG. 4. A chord may be characterised or labelled with a set of chord features. At operation 405 a value for a feature for a first chord is predicted, for example using the NADE hidden layer. Then, at operation 409 the layer is modified using the previously predicted value of the feature. The predicting and modifying are repeated until all the chord features in the set of chord features are predicted, determined at decision 407, following which the set of features is used to characterise the chord. This may then be repeated at operation 413 for all of the chords in the portion.

The equation for the activation function of the visible layer of the NADE 240 is:

$$p ( {x}_{d} \vert {x}_{< d} ) = softmax ( {V}_{d} \cdot {h}_{d} + {b}_{d} ) \qquad ( 1 )$$

The activation function of the hidden layer of the NADE 240 is:

$${h}_{d} = sigmoid ( {W}_{< d} \cdot {x}_{< d} + c ) \qquad ( 2 )$$

In the above equations: d is the dimension of the system; x_{d} is the output at dimension d; x_{<d} is the vector of all the outputs before d; p(x_{<d}) is the probability of the output at d based on the vector of all the outputs before d; V_{d} and W_{<d}, respectively, are lists of tensors of hidden-to-visible and visible-to-hidden weights; b_{d} is the value of a bias for dimension d in the visible layer; and c is the vector of biases in the hidden layer.

In an example, the hidden layer made of the NADE 240 is made of 350 neurons.

The biases for the NADE 240 are derived using the following equations:

$$b = sigmoid ( {θ}_{v} \cdot f ( x ) + {β}_{v} ) \qquad ( 3 )$$

$$c = sigmoid ( {θ}_{h} \cdot f ( x ) + {β}_{h} ) \qquad ( 4 )$$

In the above equations: b and c, respectively, represent the vector of biases in the visible layer and the hidden layer; and θ_{v/h} and β_{v/h}, respectively, are the weights and biases of the visible/hidden layer of a dense layer (in the illustrated example DenseNet 210, GRU 220, and the bottleneck layer 230 as shown in FIG. 3), which connects an arbitrary function of inputs ƒ (x) with the NADE 240 biases.

In the illustrated example, ACR is achieved with the help of RN notation. RNs provide insights into harmony theory by exposing its invariances and symmetries. They highlight the function of each chord inside the progression and, for this reason, ACR with RNs is also known as functional harmonic analysis. Other notations may be used to denote other musical styles.

The function ƒ chosen is a CRNN in the implementations described here, as it has already been proven to work well in this domain. In particular, following Micchi et al. (G. Micchi, M. Gotham, and M. Giraud, “Not All Roads Lead to Rome: Pitch Representation and Model Architecture for Automatic Harmonic Analysis,” Transactions of the International Society for Music Information Retrieval, vol. 3, no. 1, pp. 42-54, may 2020. [Online]. Available: http: //transactions.ismir.net/articles/10.5334/tismir.45/) a DenseNet (G. Huang, Z. Liu, L. Van Der Maaten, and K. Q. Weinberger, “Densely connected convolutional networks,” in Proceedings—30th IEEE Conference on Computer Vision and Pattern Recognition, CVPR 2017, vol. 2017-Janua, 2017, pp. 2261-2269. [Online]. Available: https://github.com/liuzhuang13/DenseNet) for the convolutional part and a bidirectional GRU (K. Cho, B. van Merriënboer, C. Gulcehre, D. Bahdanau, F. Bougares, H. Schwenk, and Y. Bengio, “Learning phrase representations using RNN encoder-decoder for statistical machine translation,” in Proceedings of the 2014 Conference on Empirical Methods in Natural Language Processing (EMNLP). Doha, Qatar: Association for Computational Linguistics, pp. October 2014, 1724-1734. [Online]. Available: https://www.aclweb.org/anthology/D14-1179) for the recurrent part is used, which takes care of modelling the autoregressive part of the calculations in the time domain. As shown in FIG. 2 a fully connected layer is introduced as a bottleneck in between the GRU 220 and the NADE 240. However there are other possibilities for the function ƒ.

In RN notation, each chord is defined by its relation with the tonic of the local key. The basic features of RNs are: key, degree of the scale on which the chord is built (expressed in RNs), quality of the chord (i.e. the type of triad plus any possible extension), and inversion (i.e. which of the notes is the lowest). For example, from the RN analysis in FIG. 2 we see the annotation V65 at the third measure. In the key of C (see first measure), this corresponds to a G (fifth degree of the scale) dominants seventh chord in first inversion (numerals 65). Sometimes, chords are borrowed from other keys for a very short period of time and introduce some colouring in the harmonic progression. For example a D7 chord contains an F ♯. Whenever we find such a chord in the key of C resolving to a G chord we identify it as a dominant chord borrowed from the neighbouring key of G and encode it as V7/V. Those borrowed chords are known as tonicised chords, and the tonicisation defines the relation between the local key and the temporary tonic.

Thus, in the case of harmonic analysis, the visible layer of the NADE 240 may represent a chord annotation, or feature, separated along six dimensions and organised the following order: key, tonicisation, degree, quality, inversion, and a root. However, note that the root of the chord can also be determined by using the local key, tonicisation and the degree of the chord. Further, the chord features do need to be predicted in this order. The ordering may be consistent for all the chords in the music file.

The simplest data encoding for RN notation requires 24 keys, 7 degrees, 7 tonicisations, and 4 inversions per each quality of chord. In an example, 10 chord qualities are used for ACR: 4 triads (major, minor, diminished, and augmented), 5 sevenths (major, dominant, minor, half diminished, and diminished), and augmented sixth.

When predicting all these labels at once, their sizes multiply to make a total of 47 k possible output classes. If one wants to add pitch spelling, support for alterations both in degree and in tonicisation, and a direct prediction of the root, the total number of combinations climbs up to 22 millions. Also, while the ten qualities cover most of the cases in classical music, making up for 99.98% of the dataset we consider, they do not even come close to describing the wealth of extensions and colourings that are commonly used in jazz music. In short, it is not desirable to deal directly with such a combinatorially explosive situation. Making individual predictions for each of the elementary labels that form the chord and then combining them together, results in a summation of their output sizes, rather than a multiplication, making the problem tractable.

From the RN notation it is possible to derive chord symbols. Those are defined only by root, quality, and inversion. For example, a V65 in C major in RN notation would be written in chord symbols, following the same encoding as mir_eval, as G:7/3. All information about local key and tonicisation is lost. The encoding is described for example in C. Harte, M. B. Sandler, S. A. Abdallah, and E. Gómez, “Symbolic representation of musical chords: A proposed syntax for text annotations.” in ISMIR, vol. 5, 2005, pp. 66-71, and C. Raffel, B. McFee, E. J. Humphrey, J. Salamon, O. Nieto, D. Liang, and D. P. W. Ellis, “mir_eval: A Transparent Implementation of Common MIR Metrics,” in Proc. of the 15th International Society for Music Information Retrieval Conference (ISMIR), 2014, pp. 367-372.

In recent years, several datasets of RN annotations have been published which have been collected and converted to the “rntxt” data format inside the GitHub repository in [8] M. Gotham, accessed 2021-07-29. [Online]. Available: https://github.com/MarkGotham/When-in-Rome. The size and content of the corpora used is reported in Table 1. The dataset parsing code, including fixes on known issues, is discussed in G. Micchi, accessed 2021-07-29. [Online]. Available: https://gitlab.com/algomus.fr/functional-harmony.

TABLE 1

| Dataset | Composer | Content | Crotchets | Annotations |
|---|---|---|---|---|
| Roman Text [29] | C Monteverdi | 48 Madrigals | 15,040 | 5,828 |
| | J. S. Bach | 24 Preludes | 3,168 | 2,107 |
| [31] | F. J. Haydn | 24 String Quartets | 9,113 | 4,815 |
| | | Movements | | |
| | Various | 156 Romantic Songs | 22,254 | 11,851 |
| | Various | 4 Additional | 2,649 | 1,165 |
| | | Compositions | | |
| BPS-FH [17] | L. v. Beethoven | 32 Sonata Movements | 23,554 | 8,615 |
| TAVERN [32] | W. A. Mozart | 10 theme and variations | 7,833 | 3,887 |
| | L. v. Beethoven | 17 theme and variations | 12,840 | 6,836 |
| Total | | 315 scores | 96,450 | 45,104 |

During execution of CRA 200, input data flows in the usual way along the first three parts (DenseNet 210 block, GRU 220 block, and the bottleneck layer 230 as shown in FIG. 3). As mentioned before, the output of the bottleneck layer 230 is used to determine the initial bias (see equations 3 and 4 above) of the NADE 240 block, both in its visible and hidden layers of the NADE 240. Equations 1 and 2 are then applied iteratively for all neurons in the visible layer, enabling the NADE 240 starts its usual ‘ping-pong’ process to dependently determine each of the labels for a particular chord. For example:
Ping: Starting from the hidden layer, determine the key
Pong: Use the predicted key to modify the hidden layer
Ping: Use the hidden layer to determine the tonicisation
Pong: Use the predicted tonicisation to modify the hidden layer
Ping: . . . .

The above ‘ping-pong’ process is illustrated by up and down arrows between the NADE 240, and the output 250 in FIG. 3a. The output 250 is then concatenated (operation 140) then decoded it into a human readable format, as previously mentioned.

As noted above, FIG. 4 shows a flowchart 400 including the operation of the NADE 240 within the CRA according to some embodiments of the invention. At operation 401 a portion of data from the music file is received. This will usually be in digital format and be for a particular time interval, as discussed elsewhere here. As an optional step 403, the input may be combined with previous music inputs and/or outputs (predictions), for example using an additional algorithm. In the implementation described in more detail here, the music file is input into a CRNN. The CRNN has a state (at every time step) corresponding to a history of inputs and outputs. Thus, the CRNN may combine this history with the current music file. Additionally or alternatively, the CRNN may perform any one or more of identifying local features in the music file; analysing the progression of the chords; and reducing the dimensionality of the system, before inputting the processed data to the NADE 240 for feature estimation. Note that step 403 is represented by a dotted box in FIG. 4, indicating that it is an optional step. The NADE 240 then predicts 405 a value of a feature of a chord within the music file using the hidden layer of the NADE 240, for example the key. This is the first feature in a sequence of features to be predicted. Assuming at this point there are more features to be predicted, the flow continues to operation 409 where a hidden layer of the NADE is modified using the predicted value of the first feature, e.g. the key. The NADE, now modified, is used to predict another feature of the chord, e.g. tonicisation. An iterative process is conducted in this way until all features of the chord are predicted. Thus the flow includes a checks at operation 407 to see whether or not all the features of the chord have been predicted. If not, then the NADE 200 modifies 409 the hidden layer using the previously predicted feature, then uses the modified hidden layer to predict the next feature of the chord. Once all the features of the chord have been identified, then the CRA may repeats 413 operations 405, 407, 409, 411 for subsequent intervals or time instants in the music portion. It will be appreciated that in a practical implementation, an explicit check such as operation 407 need not be implemented since at every time step all of the features may be predicted one by one according to a predetermined order,

Thus, the NADE 240 ensures that every label or feature associated with a specific chord (apart from the first one) is dependently predicted, thereby enforcing coherence between the different labels or features of the chord. In each repetition of operations 405-413, NADE 240 is used to autoregressively model the distribution of the output on the different dimensions of the chord and at a specific instant of time t.

The method of FIG. 4 may be implemented taking the chord features in a predetermined order. In a possible development of the method illustrated in FIG. 4, operations 405-409 may be repeated with at least one different order of features. The predicted values of the chord features may then be averaged to produce the set of chord features at operation 411. Depending on the number of features, all possible orders of features may be used, or a selection.

Since in the foregoing example the outputs 250 of the NADE 240 are categorical units with a variable number of classes (as opposed to a collection of binary units), the NADE described here differs in some respects from a NADE as known in the art.

Firstly, a softmax layer is applied to every feature in the output (instead of a sigmoid), as shown in equation 1. Then, to adapt to this change in the output size, the weight tensor V_{d}, which was understood to be unidimensional and of size nₕ (the number of units in the hidden layer), is instead two-dimensional and of size (n_{d}, nₕ), where n_{d} is the number of units in the current categorical output in the output layer. Similarly, the shape of W_{<d} is (nₕ, Σ_{i<d}nᵢ) instead of (nₕ, d−1).

Since the dimensionality of the weight tensors d; V_{d} and W_{<d} has now been altered, the output of the NADE 240 will be a concatenation of 1-hot vectors of all the features of the chord to be predicted. For example, assume that there are two features: the first feature has three classes and the second has two classes. Then an output vector of the NADE 240 could be A=[1, 0, 0, 0, 1], where the three first units of the vector are for the first feature with one activation at the first class, and the last two units are for the second feature with one activation at the second class.

The approach allows the weights (i.e. d; V_{d} and W_{<d}) of the NADE 240 to be updated not for every unit in the output vector A, but for every block of units in A (3 units block for the first feature, and two units block for the second feature).

The CRA 200 is trained on the task of functional harmonic analysis on symbolic scores. As mentioned previously, the input is a symbolic file (such as MusicXML or MIDI and ** kern) and the output is an aligned harmonic analysis. The model CRA 200 was tested against two state-of-the-art models: the original CRNN architecture that is used as a basis for CRA 200, and the improved Harmony Transformer model (HT*).

In an example, CRA 200 has in total 389 k trainable weights, while the original CRNN architecture has 83 k and HT* has 750 k. All the trainings use early stopping and typically require less than 20 epochs. The entire training of CRA 200 lasts for a little more than 2 hours on a recent laptop (no GPU needed). The loss function is the sum of all the categorical cross entropies applied separately to each output. Each individual collection in the dataset is split 80/20 between training and validation data.

For CRNN and CRA 200. two different representations of the input data have been implemented: “pitch class+bass” and “pitch spelling+bass”. Pitch class+bass contains 24 elements, 12 indicating all the active pitch classes (multi-hot encoded) and 12 indicating the lowest active pitch class—the bass (one-hot encoded). If pitch class+bass is used, the output labels root and key are also encoded using only pitch classes, therefore having respectively size 12 and 24 (the keys can be major or minor).

Pitch spelling+bass, instead, contains 35 elements, that is, the seven notes times five alterations (double flats, flats, diatonic, sharps, double sharps). When pitch spelling+bass is used, the output label root has shape 35 and keys 36—this is obtained keeping the 18 keys between C♭ and A ♯ in the circle of fifths in two modes, major and minor.

It was tested whether or not the addition of metrical information has a positive impact on the outcome. As mentioned earlier, in models that are trained with metrical information, the input includes two additional vectors. The first one-dimensional vector is 1 whenever a new measure begins and 0 otherwise, the second one-dimensional vector is 1 at the onset of a new beat and 0 otherwise.

The input data is quantised in time frames of the length of a demisemiquaver (1/32nd note). Due to the presence of pooling layers in the convolutional part, the output resolution is reduced and corresponds to a quaver (1/8th note).

HT* has a slightly different approach. Below two separate HT* models are presented. In both cases, the input is encoded in MIDI numbers following a piano roll representation and additionally contains information of the tonal centroids.

The first model may be trained for functional harmonic analysis and has two outputs: the key (24 categories=12 pitch classes 2 modes) and the RN annotations (5040 categories=9 tonicisations, 14 degrees, 10 qualities, 4 inversions). As mentioned before, these RN predictions are used to derive the root of the chord and therefore its chord symbol representation.

The other model is trained only for chord symbol recognition and has a single output with 25 possible categories: major and minor triads (possibly with extensions) for all the 12 pitch classes and a last category for all remaining chords. The second model is not included in the experiments because the output vocabulary is too small to be fairly compared with the other models. Such a variant would be comparable to the models trained only in case it contained the same roots, qualities, and inversions as the others, for a total of 480 output classes. Moreover, such chord symbol-oriented HT* cannot produce predictions for functional harmonic analysis because of the absence of key, tonicisation, and degree.

Evaluating the quality of a functional harmonic analysis is an extremely challenging task. First, there could be different analysis of the same music that are equally acceptable—this is a complex issue that might require a complete rethinking of the training strategies and is addressed it in the present application. Second, not all errors are equally important: one could argue that correctly identifying the inversion is less important than the root or the quality of the chord. To address this second issue, the scores on several metrics are reported and allow the readers decide which one is the most important for their task.

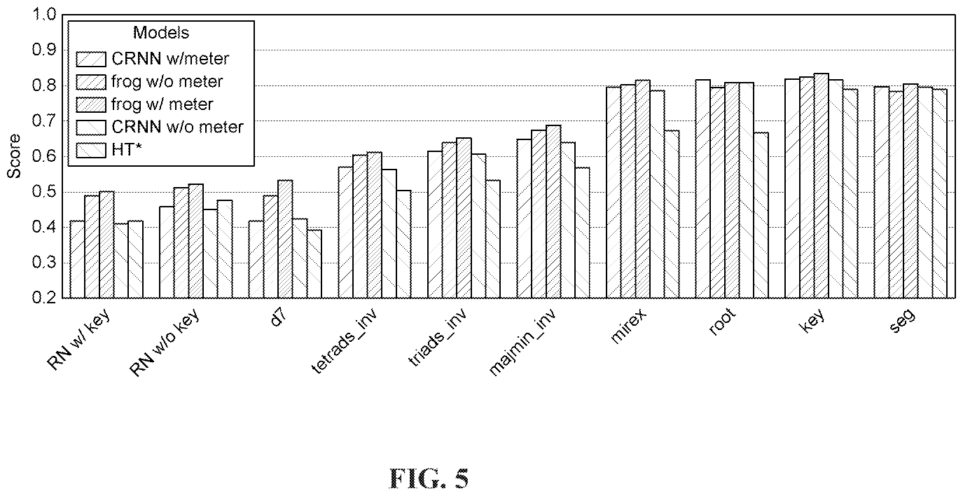

FIG. 5 is a graph comparing the scores of several metrics obtained by CRA 200 to those obtained by other methods. It can be seen that CRA 200 shows better results when compared to the previous state-of-the-art models (CRNN w/o meter and HT*) in almost every metric considered. To provide a better comparison with the HT* model, the results of the pitch class+bass input data representation are reported in FIG. 5.

The most complete metric shown is the accuracy on RNs (FIG. 5, first two metrics from the left). Two versions are presented: in the first (“RN w/o key”), the prediction is considered correct if and only if tonicisation, degree, quality, and inversion are all correct. This corresponds to the direct RN output of the HT* model. For this task, CRA 200 reports a 52.1% accuracy against the 47.6% that was obtained for HT* and 44.9% for CRNN (w/o meter).

The second case (“RN w/key”) requires also a correct prediction of the key. Here, CRA 200 still gives a correct prediction in 50.1% of cases against 41.9% that is obtained for HT* and 40.8% for CRNN. The absolute margin of improvement of CRA 200 on the best competing state-of-the-art algorithms goes from 4.5% on RN w/o key to 8.2% on the more complex task of RN w/key.

Diminished seventh are a special chord in music theory because they divide the octave in 4 equal intervals. Therefore, these highly symmetrical chords are often used during modulations. This makes them very easy preys to problems of misclassification due to the lack of coherence. In addition, they are sporadic chords, making up 4.3% of the data in the present application dataset, which makes correct predictions both difficult and important. The accuracy with CRA 200 makes a big leap from 39.1% of the HT* model and 42.4% of CRNN to 53.3%, showing a better than average result on these chords (See FIG. 5, metric “d7”).

FIG. 5 also shows a selection of the metrics included in the package mir_eval (last seven metrics to the right).

The first conclusion drawn from these results is that the HT*, which chooses its output among a large vocabulary of more than 5000 output classes, has the lowest accuracy of all systems. The more powerful variant of the ACR-oriented version of HT* mentioned earlier would however probably obtain higher scores than this general-purpose HT* on these metrics.

The second conclusion is that all models perform almost equally on segmentation. The segmentation is reported as the minimum of the score on over-segmentation and under-segmentation and for all models the minimum score is given by the over-segmentation. This could be due either to an intrinsic limitation that is common to all architectures and that needs yet to be discovered. It could be also due to the fact that human annotators might prefer a more synthetic analysis. For example, some notes could be interpreted as passing tones by humans and considered instead as structural part of the chord by the algorithm.

The CRNN and CRA 200 models predict an additional redundant output, the root, with the assumption that it helps the systems learn faster. Comparing the root derived from the RN with the one directly estimated by the model we can obtain a measure of the internal coherence of the output labels. CRNN has a root coherence of 78.9%, compared to CRA 200 which has a root coherence of 99.0%

Additionally, it was observed that the introduction of metrical information (hence tagged with “w/meter” in FIG. 5) has a positive but a relatively small impact on the results in all metrics.

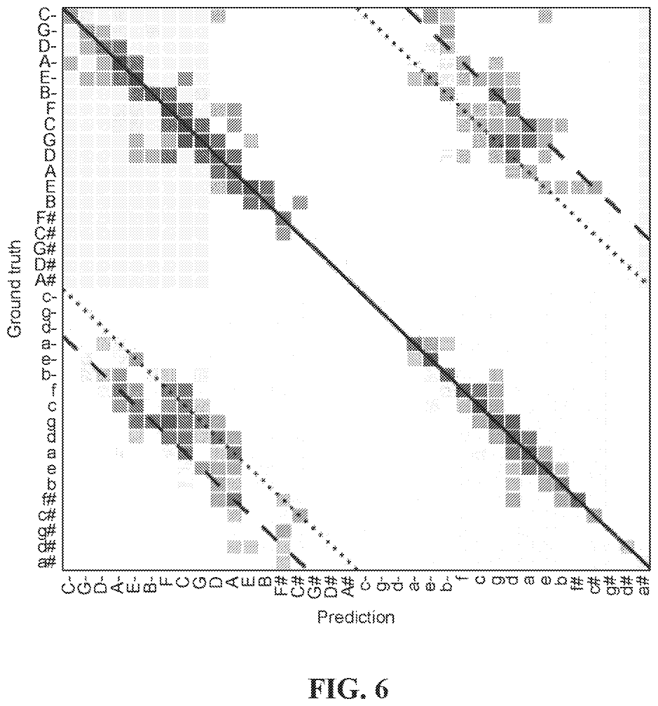

FIG. 6 shows a confusion matrix for the key obtained with CRA 200 when trained with pitch spelling. The keys are arranged according to the circle of fifths (F-C-G-D . . . ) with the major keys preceding the minor keys (i.e. the top-left quadrant shows the major/major correlation while the bottom-right the minor/minor correlation). The values reported are the occurrences of each pair ground truth/prediction and are presented in a logarithmic scale to enhance the different scales in prediction errors.

The mir_eval key metric reported in FIG. 5 assigns 1 point to all keys that are correctly predicted, 0.5 points to dominant/sub-dominant predictions (G/F instead of C), 0.3 to relative (a instead of C or vice versa), and 0.2 to parallel (c instead of C or vice versa). In FIG. 6, those cases are the ones reported on the five diagonals super-imposed to the plot: the main diagonal, in solid line, shows the correctly predicted keys. Dominant predictions are immediately to its right and sub-dominant to its left. Dashed lines show the relative predictions, while dotted lines show the parallel predictions. Some rows and columns of the confusion matrix are empty: these are the keys that are supported by the model but never used in the test dataset.

In a separate but related experiment, CRA 200 was allowed to access a key oracle. This was done by reading the key from the test data and setting it as the first output of the visible layer of the NADE 240. Then, the remaining labels were sampled autoregressively in the given order, as usual.

The impact of this key oracle on the results was measured. Without a dedicated retraining, a multi-output model with no coherence between the different labels, such as the HT* or the CRNN, would report unvaried accuracies for all elementary labels except key. This entails that the accuracy for the RN w/key prediction be equivalent to the one for RN w/o key. However, this is not what happens with CRA 200: the degree accuracy goes from 72.6% to 80.3% and the tonicisation from 91.4% to 94.0%. As a result, the accuracy on RN w/key jumps to 60.3%, much higher than the 52.1% expected in absence of coherence.

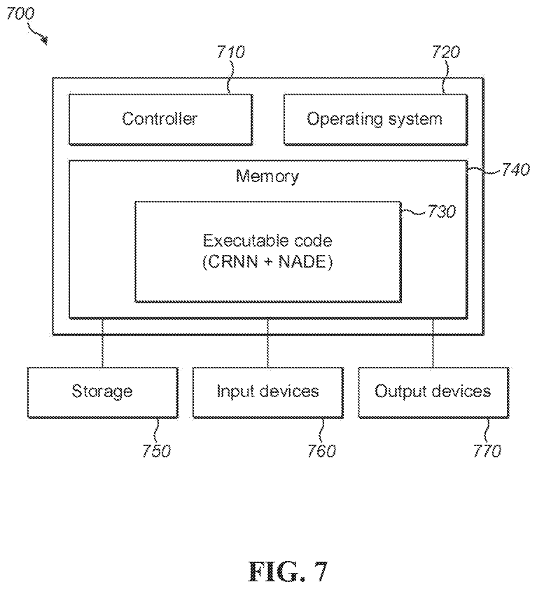

FIG. 7 is a block diagram of an exemplary computing device or system in which the methods described here may be implemented. Computing device 700 may include a controller 705 that may be, for example, a central processing unit processor (CPU), 7 or any suitable computing or computational device, an operating system 720, a memory 340, executable code 730 implementing the CRNN, a storage system 750, input devices 760 and output devices 770 which may include a display.

In a practical implementation, a user may upload a digital music file to be processed, for example via an input device 760, which may comprise any one or more of a touch screen, keyboard, mouse and other peripherals as is known in the art. The file may then be processed, for example in a method as shown in FIG. 4. The operations of FIG. 4 may be performed on all portions of the digital music file with the result that all of the chords may be classified by their predicted features. These may then be used to convert the digital music file into human readable form, such as a score that may then be played on one or more musical instruments, as is known in the art. The human readable form may be stored in memory 740 and when required it may be displayed to a user.

The foregoing describes an advancement in the field of automatic chord recognition and especially function harmonic analysis for symbolic music. The use of the ADE, or NADE, allows the separation of the complex and large vocabulary of all possible output classes into a set of elementary labels, or features (such as but not limited to key, degree and quality of the chords) while retaining strong coherence between them. This effectively reduces the size of the output classes by several orders of magnitude and at the same time offers better results, as shown in the foregoing.

A consequence of the reduction of complexity of the output labels is the increased flexibility that this model gives to the users, as changes to the chord labels do not dramatically alter the size of the model or the complexity of the task. For example, one could easily introduce a later amount of chord colourings, which makes this method a better candidate for analysing music such as jazz.

It will be appreciated that the method is not limited to the chord features described here. For example, an option would be to separate the tonic and mode (major/minor), and/or the degrees could be separated on two axes, such as position on scale and alteration.

In the methods illustrated here, different features of a chord are predicted in a particular order, and it is mentioned that different orders may be used. A possible development of the invention is the introduction of Orderless NADE, for example as described in B. Uria, I. Murray, and H. Larochelle, “A deep and tractable density estimator,” 31st International Conference on Machine Learning, ICML 2014, vol. pp. 1, 719-727, 10 2014. [Online]. Available: http://arxiv.org/abs/1310.1757. The Orderless NADE effectively trains one separate model for all the possible orderings and then averages the results obtained. Instead of all possible orderings being considered, a subset of all possibilities could be chosen.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Progrmmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method operations or elements identified, but that such operations or elements do not comprise an exclusive list and a method or apparatus may contain additional operations or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the operations of the methods described herein is exemplary, but the operations may be carried out in any suitable order, or simultaneously where appropriate. Additionally, operations may be added or substituted in, or individual operations may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method of recognising chords in music, the method comprising:
receiving music data for a time interval;
processing the music data in a machine learning model to output chord data corresponding to the time interval, the chord data comprising a set of chord features;
wherein the processing in the machine learning model comprises:
predicting a value of a chord feature from a set of chord features using an Autoregressive Distribution Estimator (ADE);
modifying the ADE using the predicted value for the chord feature;
using the modified ADE to predict a value for a different feature of the chord from the set of chord features;
repeating the modifying and predicting until a value for each of the features in the set of chord features have been predicted.

2. The method of claim 1 wherein the step of modifying the ADE comprises modifying a hidden layer of the ADE, wherein the hidden layer optionally comprises a sigmoid activation function.

3. The method of claim 1, wherein a visible layer of the ADE comprises a softmax activation function.

4. The method of claim 1, wherein the set of chord features comprises any one or more of chord root, local key, tonicisation, degree, chord quality, and inversion.

5. The method of claim 4, wherein the method further comprises predicting each of the features in the following order: a local key, tonicisation, degree, chord quality, inversion, and root of the chord.

6. The method of claim 1, wherein the ADE is a Neural Autoregressive Distribution Estimator (NADE).

7. The method of claim 1 comprising combining the received music data with one or both of previously received music data and previously output chord data, and inputting the combined data to the ADE.

8. The method of claim 1, wherein the combining is performed in a recurrent neural network “RNN”, optionally a Convolutional Recurrent Neural Network (CRNN).

9. The method of claim 8 wherein the state of the RNN is used to determine initial biases for the ADE.

10. The method of claim 8, wherein the combining is performed in a CRNN comprising: a Dense Convolutional Network, a bi-directional Gated Recurrent Unit, and a bottleneck layer, wherein optionally an output of the bottleneck layer is used to determine the initial biases for the ADE.

11. The method of claim 1, wherein the output of the ADE is a concatenation of 1-hot vectors of all the features to be predicted for the chord, and optionally comprising concatenating all outputs of the ADE and converting the concatenated output into a harmonic annotated music file.

12. The method of claim 1 comprising parsing the portion of music from a symbolic music file, optionally comprising obtaining one or both of a multi-hot 2-dimensional presentation of all notes in the music file and a multi-hot 2-dimensional presentation of a metrical structure in the music file.

13. The method of claim 1 comprising performing the predicting, modifying and repeating with at least one different order of features and averaging the predicted values of the chord features to produce the set of chord features.

14. A data processing system comprising:
at least one processor; and
at least one memory storing instructions that, when executed by the at least one processor, cause the data processing system at least to:
receive music data for a time interval;
process the music data in a machine learning model to output chord data corresponding to the time interval, the chord data comprising a set of chord features;
wherein the processing in the machine learning model comprises:
predicting a value of a chord feature from a set of chord features using an Autoregressive Distribution Estimator (ADE);
modifying the ADE using the predicted value for the chord feature;
use the modified ADE to predict a value for a different feature of the chord from the set of chord features;
repeat the modifying and predicting until a value for each of the features in the set of chord features have been predicted.

15. A non-transitory computer-readable medium comprising instructions which, when executed by a processor in a computing system, cause the computer to:
receive music data for a time interval;
process the music data in a machine learning model to output chord data corresponding to the time interval, the chord data comprising a set of chord features;
wherein the processing in the machine learning model comprises:
predicting a value of a chord feature from a set of chord features using an Autoregressive Distribution Estimator (ADE);
modifying the ADE using the predicted value for the chord feature;
use the modified ADE to predict a value for a different feature of the chord from the set of chord features;
repeat the modifying and predicting until a value for each of the features in the set of chord features have been predicted.

16. The non-transitory computer-readable medium of claim 15, wherein the step of modifying the ADE comprises modifying a hidden layer of the ADE, wherein the hidden layer optionally comprises a sigmoid activation function.

17. The non-transitory computer-readable medium of claim 15, wherein a visible layer of the ADE comprises a softmax activation function.

18. The non-transitory computer-readable medium of claim 15, wherein the set of chord features comprises any one or more of chord root, local key, tonicisation, degree, chord quality, and inversion.

19. The non-transitory computer-readable medium of claim 18, wherein the computer is further caused to predicting each of the features in the following order: a local key, tonicisation, degree, chord quality, inversion, and root of the chord.

20. The non-transitory computer-readable medium of claim 15, wherein the ADE is a Neural Autoregressive Distribution Estimator (NADE).
